(19) United States
(12) Patent Application Publication
(10) Pub. No.: US 2022/0060688 A1
(43) Pub. Date: Feb. 24, 2022

(54) SYNTAX FOR MOTION INFORMATION SIGNALING IN VIDEO CODING

(71) Applicant: InterDigital VC Holdings, lnc., Wilmington, DE (US)

(72) Inventors: Franck GALPIN, Thorigne-Fouillard (FR); Fabrice LELEANNEC, Mouazé (FR); Fabrice URBAN, THORIGNE FOUlLLARD (FR)

(21) Appl. No.: 17/413,866

(22) PCT Filed: Dec. 19, 2019
(86) PCT No.: PCT/US2019/067336

§ 371 Date: Jun. 14, 2021

(30) Foreign Application Priority Data
Dec. 21, 2018 (EP) 18306816.2

(51) Int. Cl. H04N 19/105; H04N 19/139; H04N 19/70; H04N 19/107

(52) U.S. Cl. CPC H04N 19/105; H04N 19/107; H04N 19/70; H04N 19/139

(57) ABSTRACT

In an encoding apparatus or a decoding apparatus, an encoding method or decoding method encodes or decodes a bitstream comprising a unified syntax for coding motion information in video coding providing great flexibility for the mode choices through a large number of available modes related to the motion information. The unified motion information syntax comprises modes for both bi-prediction or uni-prediction and introduces a new skip mode that provides a finer cost granularity.

### TECHNICAL FIELD

At least one of the present embodiments generally relates to the field of video compression. At least one embodiment particularly aims at unified syntax for coding motion information in video coding.

### BACKGROUND

To achieve high compression efficiency, image and video coding schemes usually employ prediction and transform to leverage spatial and temporal redundancy in the video content. Generally, intra or inter prediction is used to exploit the intra or inter frame correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

One or more of the present embodiments relates to a unified syntax for coding motion information in video coding that provides great flexibility for the mode choices through a large number of available modes related to the motion information. The unified motion information syntax comprises modes for both bi-prediction or uni-prediction and introduces a new skip mode that provides a finer cost granularity.

According to a first aspect of at least one embodiment, a video encoding method comprises, for a block of a video, encoding the block and corresponding signaling information representative of a motion information coding mode for the block, wherein the signaling information comprises an information representative of a uni-directional prediction mode where motion information is predicted from an index in a candidate list of predictors.

According to a second aspect of at least one embodiment, a video decoding method comprises, for a block of a video, decoding the block and corresponding signaling information representative of a motion information coding mode for the block, wherein the signaling information comprises an information representative of a uni-directional prediction mode where motion information is predicted from an index in a candidate list of predictors.

According to a third aspect of at least one embodiment, a video encoding apparatus comprises an encoder configured to encode a block of a video and corresponding signaling information representative of a motion information coding mode for the block, wherein the signaling information comprises an information representative of a uni-directional prediction mode where motion information is predicted from an index in a candidate list of predictors.

According to a fourth aspect of at least one embodiment, a video decoding apparatus comprises a decoder configured to decode a block of a video and corresponding signaling information representative of a motion information coding mode for the block, wherein the signaling information comprises an information representative of a uni-directional prediction mode where motion information is predicted from an index in a candidate list of predictors.

According to a fifth aspect of at least one embodiment, a bitstream is formed by encoding a block of a video and corresponding signaling information representative of a motion information coding mode for the block, wherein the signaling information comprises an information representative of a uni-directional prediction mode where motion information is predicted from an index in a candidate list of predictors and forming the bitstream comprising the encoded current block.

According to variants of first, second, third, fourth and fifth embodiments, the signaling information further comprises an information representative of a bi-directional prediction mode where motion information is fully described for one prediction and is predicted from an index to a candidate list of predictors for the second prediction.

According to variants of first, second, third, fourth and fifth embodiments, the signaling information further comprises a super-skip flag at the root of the motion information syntax graph to signal that motion information is predicted from a unique candidate signaled by an index in a candidate list of predictors.

According to a sixth aspect of at least one embodiment, a computer program comprising program code instructions executable by a processor is presented, the computer program implementing the steps of a method according to at least the first or second aspect.

According to a seventh aspect of at least one embodiment, a computer program product which is stored on a non-transitory computer readable medium and comprises program code instructions executable by a processor is presented, the computer program product implementing the steps of a method according to at least the first or second aspect.

### BRIEF DESCRIPTION OF THE DRAWINGS

FIG. 1 illustrates a block diagram of an example of video encoder 100.

FIG. 2 illustrates a block diagram of an example of video decoder 200.

FIG. 3 illustrates a block diagram of an example of a system in which various aspects and embodiments are implemented.

FIG. 4 illustrates an overview of an example of inter prediction system.

FIG. 5 illustrates the triangle prediction.

FIG. 6 illustrates an example of weighting process for the Triangle prediction.

FIG. 7 illustrates an example of multi-hypothesis prediction in case of inter and intra modes combination.

FIG. 8 illustrates the shapes used for the 4 intra prediction used in multi-hypothesis.

FIG. 9 illustrates an example of generalized bi-prediction (GBi) mode.

FIG. 10 illustrates an example of MMVD in the case of bi-prediction mode.

FIG. 11 illustrates an example of symmetrical MVD (SMVD).

FIGS. 12A and 12B illustrate a graph representing an example syntax tree for a video codec supporting MMVD and SMVD.

FIG. 13 illustrates a simplified version of the parsing tree of the inter mode.

FIG. 14 illustrates the candidates used for the merge list creation in each mode of a conventional video codec such as described in VTM 3.0 for example.

FIG. 15 illustrates a first example of motion information parsing tree according to at least an embodiment.

FIG. 16 shows an example of process for constructing a L0 uni-prediction merge list by using the merge list creation.

FIG. 17 illustrates a second example of motion information parsing tree according to at least an embodiment.

FIG. 18 illustrates a simplified view of the parsing tree of the inter mode.

FIG. 19 illustrates a third example of motion information parsing tree according to at least an embodiment.

FIG. 20 illustrates a fourth example of motion information parsing tree according to at least an embodiment.

FIG. 21 illustrates a variant embodiment of the fourth example of motion information parsing tree.

FIG. 22 illustrates a variant embodiment of the fourth example of motion information parsing tree applied to a VTM 3.0 syntax.

FIGS. 23A and 23B illustrate a second variant embodiment of the fourth example of motion information parsing tree.

### DETAILED DESCRIPTION

Various embodiments relate to the use of multiple transforms selection for video encoding or decoding of intra sub block partitions. Various methods and other aspects described in this application can be used for signaling and selection of the transform to be used according to various parameters.

Moreover, the present aspects, although describing principles related to particular drafts of VVC (Versatile Video Coding according to draft 3 for example) or to HEVC (High Efficiency Video Coding) specifications, are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

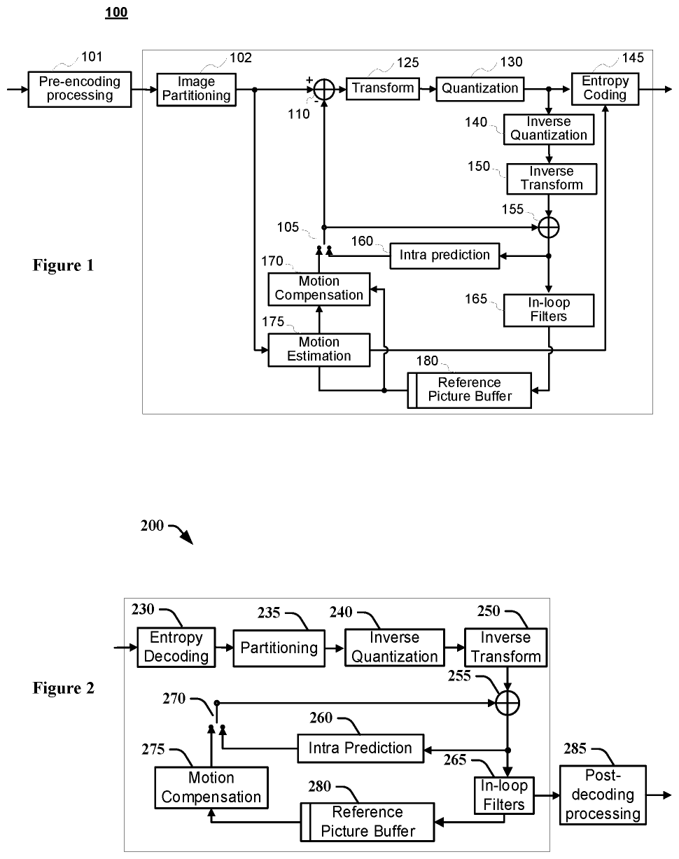

FIG. 1 illustrates block diagram of an example of video encoder 100, such as a HEVC encoder. FIG. 1 may also illustrate an encoder in which improvements are made to the HEVC standard or an encoder employing technologies similar to HEVC, such as a JEM (Joint Exploration Model) encoder under development by JVET (Joint Video Exploration Team) for VVC.

Before being encoded, the video sequence can go through pre-encoding processing (101). This is for example performed by applying a color transform to the input color picture (for example, conversion from RGB 4:4:4 to YCbCr 4:2:0) or performing a remapping of the input picture components in order to get a signal distribution more resilient to compression (for instance using a histogram equalization of one of the color components). Metadata can be associated with the pre-processing and attached to the bitstream.

In HEVC, to encode a video sequence with one or more pictures, a picture is partitioned (102) into one or more slices where each slice can include one or more slice segments. A slice segment is organized into coding units, prediction units, and transform units. The HEVC specification distinguishes between “blocks” and “units,” where a “block” addresses a specific area in a sample array (for example, luma, Y), and the “unit” includes the collocated blocks of all encoded color components (Y, Cb, Cr, or monochrome), syntax elements, and prediction data that are associated with the blocks (for example, motion vectors).

For coding in HEVC, a picture is partitioned into coding tree blocks (CTB) of square shape with a configurable size, and a consecutive set of coding tree blocks is grouped into a slice. A Coding Tree Unit (CTU) contains the CTBs of the encoded color components. A CTB is the root of a quadtree partitioning into Coding Blocks (CB), and a Coding Block may be partitioned into one or more Prediction Blocks (PB) and forms the root of a quadtree partitioning into Transform Blocks (TBs). Corresponding to the Coding Block, Prediction Block, and Transform Block, a Coding Unit (CU) includes the Prediction Units (PUs) and the tree-structured set of Transform Units (TUs), a PU includes the prediction information for all color components, and a TU includes residual coding syntax structure for each color component. The size of a CB, PB, and TB of the luma component applies to the corresponding CU, PU, and TU. In the present application, the term “block” can be used to refer, for example, to any of CTU, CU, PU, TU, CB, PB, and TB. In addition, the “block” can also be used to refer to a macroblock and a partition as specified in H.264/AVC or other video coding standards, and more generally to refer to an array of data of various sizes.

In the example of encoder 100, a picture is encoded by the encoder elements as described below. The picture to be encoded is processed in units of CUs. Each CU is encoded using either an intra or inter mode. When a CU is encoded in an intra mode, it performs intra prediction (160). In an inter mode, motion estimation (175) and compensation (170) are performed. The encoder decides (105) which one of the intra mode or inter mode to use for encoding the CU and indicates the intra/inter decision by a prediction mode flag. Prediction residuals are calculated by subtracting (110) the predicted block from the original image block.

CUs in intra mode are predicted from reconstructed neighboring samples within the same slice. A set of 35 intra prediction modes is available in HEVC, including a DC, a planar, and 33 angular prediction modes. The intra prediction reference is reconstructed from the row and column adjacent to the current block. The reference extends over two times the block size in the horizontal and vertical directions using available samples from previously reconstructed blocks. When an angular prediction mode is used for intra prediction, reference samples can be copied along the direction indicated by the angular prediction mode.

The applicable luma intra prediction mode for the current block can be coded using two different options. If the applicable mode is included in a constructed list of six most probable modes (MPM), the mode is signaled by an index in the MPM list. Otherwise, the mode is signaled by a fixed-length binarization of the mode index. The six most probable modes are derived from the intra prediction modes of the top and left neighboring blocks (see table 1 below).

TABLE 1

| Conditions | | | MPM[0] | MPM[1] | MPM[2] | MPM[3] | MPM[4] | MPM[5] |
|---|---|---|---|---|---|---|---|---|
| L = A | L ≠ PLANAR_IDX and | | PLANAR_IDX | L | L − 1 | L + 1 | DC_IDX | L − 2 |
| | L ≠ DC_IDX | | | | | | | |
| | Otherwise | | PLANAR_IDX | DC_IDX | VER_IDX | HOR_IDX | VER_IDX − 4 | VER_IDX + 4 |
| L ≠ A | L > DC_IDX and A > | | PLANAR_IDX | L | A | DC_IDX | Max(L, A) − | Max(L, A) + |
| | DC_IDX | | | | | | 2, if L and A | 2, if L and A |
| | | | | | | | are adjacent | are adjacent |
| | | | | | | | else | else |
| | | | | | | | max(L, A) − 1 | max(L, A) + 1 |
| | Otherwise | L + A >= | PLANAR_IDX | Max(L, A) | DC_IDX | Max(L, A) − | Max(L, A) + 1 | Max(L, A) − 2 |
| | | 2 | | | | 1 | | |
| | | otherwise | PLANAR_IDX | DC_IDX | VER_IDX | HOR_IDX | VER_IDX − 4 | VER_IDX + 4 |

For an inter CU, the motion information (for example, motion vector and reference picture index) can be signaled in multiple methods, for example “merge mode” or “advanced motion vector prediction (AMVP)”.

In the merge mode, a video encoder or decoder assembles a candidate list based on already coded blocks, and the video encoder signals an index for one of the candidates in the candidate list. At the decoder side, the motion vector (MV) and the reference picture index are reconstructed based on the signaled candidate.

In AMVP, a video encoder or decoder assembles candidate lists based on motion vectors determined from already coded blocks. The video encoder then signals an index in the candidate list to identify a motion vector predictor (MVP) and signals a motion vector difference (MVD). At the decoder side, the motion vector (MV) is reconstructed as MVP+MVD. The applicable reference picture index is also explicitly coded in the CU syntax for AMVP.

The prediction residuals are then transformed (125) and quantized (130), including at least one embodiment for adapting the chroma quantization parameter described below. The transforms are generally based on separable transforms. For example, a DCT transform is first applied in the horizontal direction, then in the vertical direction. In recent codecs such as the JEM, the transforms used in both directions may differ (for example, DCT in one direction, DST in the other one), which leads to a wide variety of 2D transforms, while in previous codecs, the variety of 2D transforms for a given block size is usually limited.

The quantized transform coefficients, as well as motion vectors and other syntax elements, are entropy coded (145) to output a bitstream. The encoder may also skip the transform and apply quantization directly to the non-transformed residual signal on a 4×4 TU basis. The encoder may also bypass both transform and quantization, that is, the residual is coded directly without the application of the transform or quantization process. In direct PCM coding, no prediction is applied and the coding unit samples are directly coded into the bitstream.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture, for example, to perform deblocking/SAO (Sample Adaptive Offset) filtering to reduce encoding artifacts. The filtered image is stored at a reference picture buffer (180).

FIG. 2 illustrates a block diagram of an example of video decoder 200, such as an HEVC decoder. In the example of decoder 200, a bitstream is decoded by the decoder elements as described below. Video decoder 200 generally performs a decoding pass reciprocal to the encoding pass as described in FIG. 1, which performs video decoding as part of encoding video data. FIG. 2 may also illustrate a decoder in which improvements are made to the HEVC standard or a decoder employing technologies similar to HEVC, such as a JEM decoder.

In particular, the input of the decoder includes a video bitstream, which may be generated by video encoder 100. The bitstream is first entropy decoded (230) to obtain transform coefficients, motion vectors, picture partitioning information, and other coded information. The picture partitioning information indicates the size of the CTUs, and a manner a CTU is split into CUs, and possibly into PUs when applicable. The decoder may therefore divide (235) the picture into CTUs, and each CTU into CUs, according to the decoded picture partitioning information. The transform coefficients are de-quantized (240) including at least one embodiment for adapting the chroma quantization parameter described below and inverse transformed (250) to decode the prediction residuals.

Combining (255) the decoded prediction residuals and the predicted block, an image block is reconstructed. The predicted block may be obtained (270) from intra prediction (260) or motion-compensated prediction (that is, inter prediction) (275). As described above, AMVP and merge mode techniques may be used to derive motion vectors for motion compensation, which may use interpolation filters to calculate interpolated values for sub-integer samples of a reference block. In-loop filters (265) are applied to the reconstructed image. The filtered image is stored at a reference picture buffer (280).

The decoded picture can further go through post-decoding processing (285), for example, an inverse color transform (for example conversion from YCbCr 4:2:0 to RGB 4:4:4) or an inverse remapping performing the inverse of the remapping process performed in the pre-encoding processing (101). The post-decoding processing may use metadata derived in the pre-encoding processing and signaled in the bitstream.

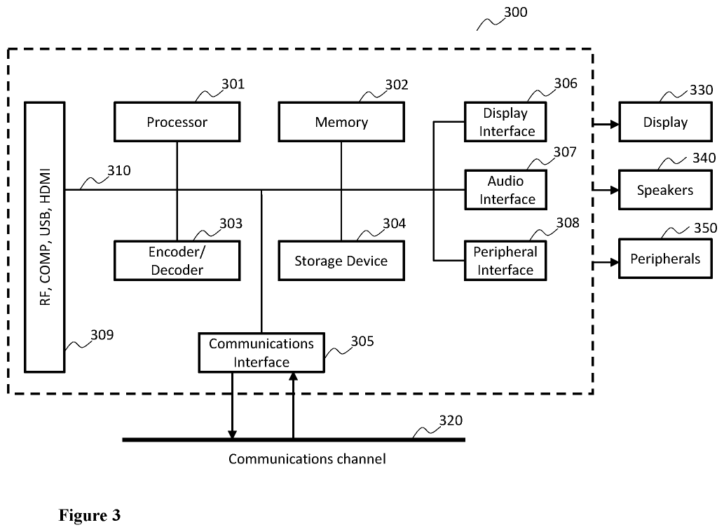

FIG. 3 illustrates a block diagram of an example of a system in which various aspects and embodiments are implemented. System 300 can be embodied as a device including the various components described below and is configured to perform one or more of the aspects described in this application. Examples of such devices include, but are not limited to, various electronic devices such as personal computers, laptop computers, smartphones, tablet computers, digital multimedia set top boxes, digital television receivers, personal video recording systems, connected home appliances, encoders, transcoders, and servers. Elements of system 300, singly or in combination, can be embodied in a single integrated circuit, multiple ICs, and/or discrete components. For example, in at least one embodiment, the processing and encoder/decoder elements of system 300 are distributed across multiple ICs and/or discrete components. In various embodiments, the elements of system 300 are communicatively coupled through an internal bus 310. In various embodiments, the system 300 is communicatively coupled to other similar systems, or to other electronic devices, via, for example, a communications bus or through dedicated input and/or output ports. In various embodiments, the system 300 is configured to implement one or more of the aspects described in this document, such as the video encoder 100 and video decoder 200 described above and modified as described below.

The system 300 includes at least one processor 301 configured to execute instructions loaded therein for implementing, for example, the various aspects described in this document. Processor 301 can include embedded memory, input output interface, and various other circuitries as known in the art. The system 300 includes at least one memory 302 (e.g., a volatile memory device, and/or a non-volatile memory device). System 300 includes a storage device 304, which can include non-volatile memory and/or volatile memory, including, but not limited to, EEPROM, ROM, PROM, RAM, DRAM, SRAM, flash, magnetic disk drive, and/or optical disk drive. The storage device 304 can include an internal storage device, an attached storage device, and/or a network accessible storage device, as non-limiting examples.

System 300 includes an encoder/decoder module 303 configured, for example, to process data to provide an encoded video or decoded video, and the encoder/decoder module 303 can include its own processor and memory. The encoder/decoder module 303 represents module(s) that can be included in a device to perform the encoding and/or decoding functions. As is known, a device can include one or both of the encoding and decoding modules. Additionally, encoder/decoder module 303 can be implemented as a separate element of system 300 or can be incorporated within processor 301 as a combination of hardware and software as known to those skilled in the art.

Program code to be loaded onto processor 301 or encoder/decoder 303 to perform the various aspects described in this document can be stored in storage device 304 and subsequently loaded onto memory 302 for execution by processor 301. In accordance with various embodiments, one or more of processor 301, memory 302, storage device 304, and encoder/decoder module 303 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In several embodiments, memory inside of the processor 301 and/or the encoder/decoder module 303 is used to store instructions and to provide working memory for processing that is needed during encoding or decoding. In other embodiments, however, a memory external to the processing device (for example, the processing device can be either the processor 301 or the encoder/decoder module 303) is used for one or more of these functions. The external memory can be the memory 302 and/or the storage device 304, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC.

The input to the elements of system 300 can be provided through various input devices as indicated in block 309. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 309 have associated respective input processing elements as known in the art. For example, the RF portion can be associated with elements necessary for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 300 to other electronic devices across USB and/or HDMI connections. It is to be understood that various aspects of input processing, for example, Reed-Solomon error correction, can be implemented, for example, within a separate input processing IC or within processor 301 as necessary. Similarly, aspects of USB or HDMI interface processing can be implemented within separate interface ICs or within processor 301 as necessary. The demodulated, error corrected, and demultiplexed stream is provided to various processing elements, including, for example, processor 301, and encoder/decoder 303 operating in combination with the memory and storage elements to process the data-stream as necessary for presentation on an output device.

Various elements of system 300 can be provided within an integrated housing, Within the integrated housing, the various elements can be interconnected and transmit data therebetween using suitable connection arrangement, for example, an internal bus as known in the art, including the I2C bus, wiring, and printed circuit boards.

The system 300 includes communication interface 305 that enables communication with other devices via communication channel 320. The communication interface 305 can include, but is not limited to, a transceiver configured to transmit and to receive data over communication channel 320. The communication interface 305 can include, but is not limited to, a modem or network card and the communication channel 320 can be implemented, for example, within a wired and/or a wireless medium.

Data is streamed to the system 300, in various embodiments, using a Wi-Fi network such as IEEE 802.11. The Wi-Fi signal of these embodiments is received over the communications channel 320 and the communications interface 305 which are adapted for Wi-Fi communications. The communications channel 320 of these embodiments is typically connected to an access point or router that provides access to outside networks including the Internet for allowing streaming applications and other over-the-top communications. Other embodiments provide streamed data to the system 300 using a set-top box that delivers the data over the HDMI connection of the input block 309. Still other embodiments provide streamed data to the system 300 using the RF connection of the input block 309.

The system 300 can provide an output signal to various output devices, including a display 330, speakers 340, and other peripheral devices 350. The other peripheral devices 350 include, in various examples of embodiments, one or more of a stand-alone DVR, a disk player, a stereo system, a lighting system, and other devices that provide a function based on the output of the system 300. In various embodiments, control signals are communicated between the system 300 and the display 330, speakers 340, or other peripheral devices 350 using signaling such as AV.Link, CEC, or other communications protocols that enable device-to-device control with or without user intervention. The output devices can be communicatively coupled to system 300 via dedicated connections through respective interfaces 306, 307, and 308. Alternatively, the output devices can be connected to system 300 using the communications channel 320 via the communications interface 305. The display 330 and speakers 340 can be integrated in a single unit with the other components of system 300 in an electronic device such as, for example, a television. In various embodiments, the display interface 306 includes a display driver, such as, for example, a timing controller (T Con) chip.

The display 330 and speaker 340 can alternatively be separate from one or more of the other components, for example, if the RF portion of input 309 is part of a separate set-top box. In various embodiments in which the display 330 and speakers 340 are external components, the output signal can be provided via dedicated output connections, including, for example, HDMI ports, USB ports, or COMP outputs. The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

The encoder 100 of FIG. 1, decoder 200 of FIG. 2 and system 300 of FIG. 3 are adapted to implement at least one of the embodiments described below.

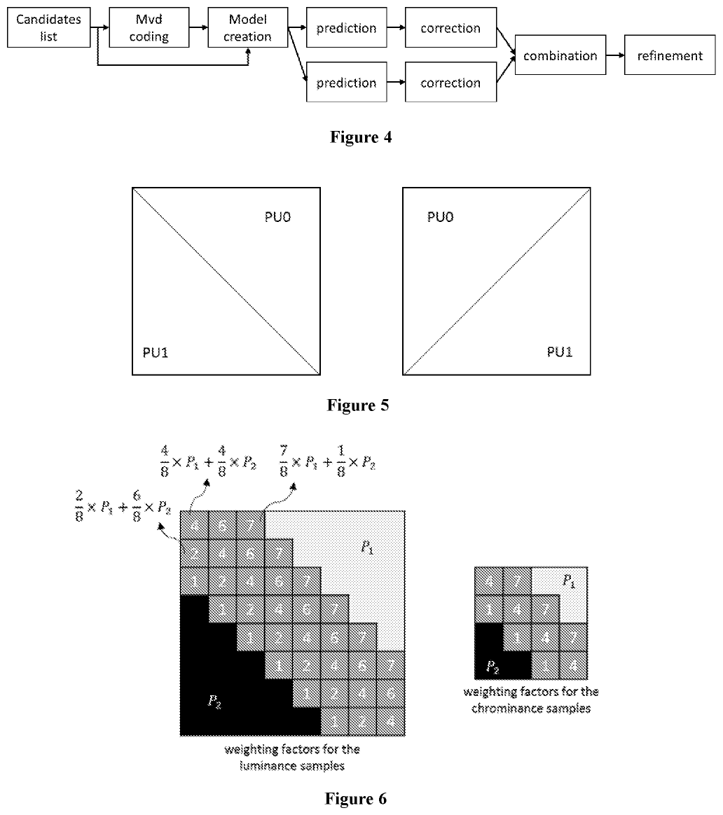

FIG. 4 illustrates an overview of an example of inter prediction system. Video encoding and decoding may use different tools for the inter prediction. Error! Reference source not found. shows tools associated to each stage of the pipeline. Example of tools for candidate list stage are “merge list”, “affine merge list”, “MMVD list”, “triangle list”, “AMVP list” or AMVP affine list”. Example of tools for the Motion Vector Difference (MVD) coding stage are MVD, Merge with MVD (MMVD), MVDD affine, Symmetric Motion vector difference (SMVD). Example of tools for the model creation stage are Block, Affine, ATMVP, Planar, RMVF. Example of tools for the correction stage are Local Illumination Compensation (LIC), OBMC. Example of tools for the refinement stage are BIO, DMVR.

Example of tools for the combination stage are Unipred, Bipred, GBI, Triangle, MultiHypothesis, hereafter called combination tools:
Uni-prediction is similar to the HEVC uni-prediction
Bi-predictionis similar to the HEVC bi-prediction
Triangular prediction (TRIANGLE) is a prediction composed of 2 predictions, but instead of a simple blending, each prediction will cover a part of a Partition Unit (PU). The boundaries between the prediction is blended.
Multi-hypothesis (MH) is a combination of a regular inter prediction and an intra prediction to form a block prediction. The blending between the 2 predictions depends of the intra direction.
Generalized Bi-prediction (GBI) is a regular bi-prediction that uses alternative weighting during the blending of the 2 predictions.

The following paragraphs describe some of these combination tools.

FIG. 5 illustrates the triangle prediction. TRIANGLE is a prediction composed of 2 predictions, but instead of a simple blending, each prediction will cover a part of the PU. The boundaries between the prediction is blended. As shown in FIG. 5 a Coding Unit (CU) is split into two triangular Prediction Units (PUs), either in diagonal or inverse diagonal direction. Each triangular Prediction Unit in the CU is inter-predicted using its own motion vector and reference frame index which are derived from a merge candidate list.

FIG. 6 illustrates an example of weighting process for the Triangle prediction. An adaptive weighting process is applied to the prediction samples of diagonal or inverse diagonal edge between the two triangular Prediction Units to derive the final prediction samples values for the whole CU as shown in FIG. 6. The triangular Prediction Unit mode is only applied to CUs in skip or merge mode. When the triangular Prediction Unit mode is applied to the CU, an index (triangle_merge_idx) indicating the direction of splitting the CU into two triangular Prediction Units, plus the motion vectors of the two triangular Prediction Units, are signaled. The partitions can be generalized to other partitions shape.

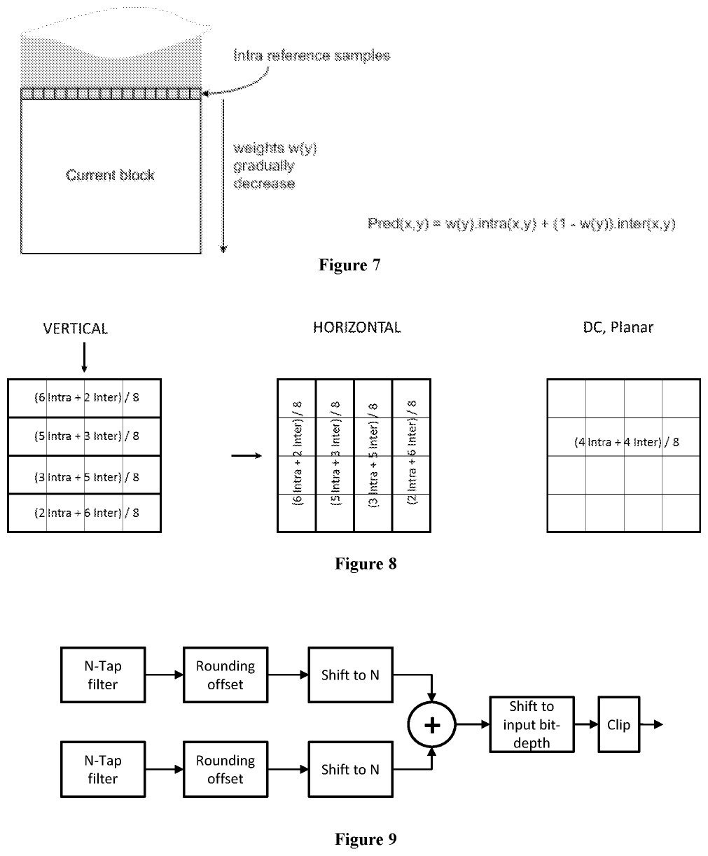

FIG. 7 illustrates an example of multi-hypothesis prediction in case of inter and intra modes combination. Multi-hypothesis combines a regular inter prediction and an intra prediction together to form a block prediction. The blending between the 2 predictions depends of the intra direction. More precisely, Multi-hypothesis combines an inter prediction performed in merge mode (merge index is signaled to derive the motion information used for the motion compensated prediction) with an intra prediction mode or with another inter mode (e.g. uni-prediction AMVP, skip or merge). The final prediction is the weighted average of the merge indexed prediction and the prediction generated by the intra prediction mode, where different weights are applied depending on the intra direction and the distance between the current sample and intra reference sample. The intra prediction mode is signaled (it can be a subset (e.g. 4) of the complete set of prediction modes). As illustrated in FIG. 5, The current block is split into 4 equal-area regions. The weights gradually decrease as the region is far from the intra reference samples. Each weight set, denoted as (w_intrai, w_interi), where i is from 1 to 4 and (w_intra1, w_inter1)=(6, 2), (w_intra2, w_inter2)=(5, 3), (w_intra3, w_inter3)=(3, 5), and (w_intra4, w_inter4)=(2, 6), will be applied to a corresponding region, as depicted in example of FIG. 7 for intra vertical direction prediction. When DC or planar mode is selected, or the CU width or height is smaller than 4, equal weights are applied for all samples. In intra prediction in Multi hypothesis CUs, chroma components use Direct mode (same intra direction as luma). FIG. 8 illustrates the shapes used for the 4 intra prediction used in multi-hypothesis.

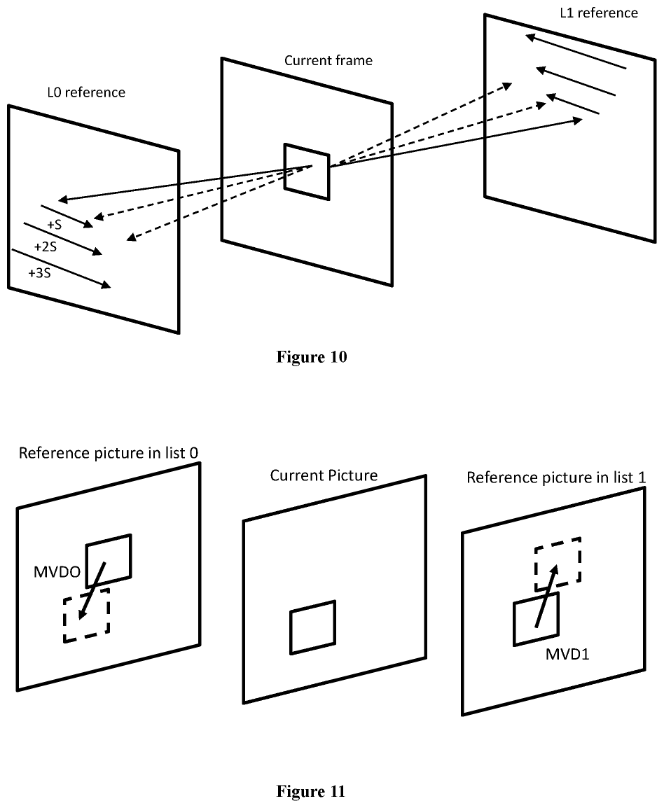

FIG. 9 illustrates an example of generalized bi-prediction (GBi) mode. This mode allows to predicts a block by combining two motion-compensated prediction blocks using block-level adaptive weights from a pre-defined set of candidate weights. As such, the prediction process of GBi can reuse the existing logics of weighted prediction, and no extra decoding burden is introduced. In HEVC, the averaging of 2 uni-directional prediction signals for bi-prediction is done at a higher precision than either the input or internal bit depth as shown in FIG. 9.

The bi-prediction formula is shown in Equation 1, where offset and shift are used to normalize the final predictor to input bit depth.

P_{bidir}=(P_{L0}+P_{L1}+offset)>>shift Equation 1

As there is no rounding in intermediate stages, interpolation filter allows certain implementation optimizations.

Multiple weights can be used for averaging 2 uni-directional prediction to get a bi-directional prediction. Typically, the weights used are {-1/4, 5/4}, {3/8, 5/8} or {1/2, 1/2} (as in HEVC), and the bi-prediction formula is modified as in Equation 2. Only one weight is used for the entire block.

P_{bidir}=((1−w₁)*P_{L0}+w₁*P_{L1}+offset)>>shift Equation 2

Moreover several ways to signal motion information are complementing the conventional AMVP (Advanced Motion Vector Prediction), MERGE/SKIP modes, with uni-prediction and bi-prediction:
MMVD (merge motion vector difference): a residual of motion vector coding is added to the merge mode. In bi-directional mode, only one residual is transmitted, symmetrized for the second prediction.
SMVD (Symmetrical Motion Vector Difference): a simplified residual of motion vector coding is added to the AMVP mode
In triangle mode, the motion vector predictor can be derived from the L0 list or L1 list for any predictor. These lists are the two lists conventionally used for motion vector prediction that contain references of blocks from which some predictions might be done.

MMVD only applies in Merge mode. It uses the merge candidate list. A flag “mmvd_skip” indicates if MMVD mode applies or not. When the mode applies, a motion vector difference (mmvd) is built as:
A syntax element (noted here as mmvd_idx) is signalled to build the corrective motion vector (MV) mmvd, consisting of the following information:
   The base MV index, chosen by the encoder among the two first translational merge candidates.
   An index noted mmvd_dir_idx related to a direction D in the (x,y) coordinate system (currently 4) (a table dir[ ] of 4 elements {(0,1), (1,0), (−1,0), (0,−1)} is specified)
   An index noted mmvd_dist_idx related to a distance step S from the base MV (currently up to 8 distances are possible, with the specification of a table dist[ ] of 8 elements {1/4-pel, 1/2-pel, 1-pel, 2-pel, 4-pel, 8-pel, 16-pel, 32-pel})

When MMVD mode is applied, the MV difference is then computed as

refinementMV=dir[mmvd_dir_idx]*dist[mmvd_dist_idx]

One single MV difference is signaled, even if the CU is coded in bi-prediction.

FIG. 10 illustrates an example of MMVD in the case of bi-prediction mode. In this case, two symmetrical MV differences are obtained from the single coded MV. When the temporal distances between the predicted picture and the reference picture differ between reference picture lists L0 and L1, then the decoded mmvd is assigned to the MV difference (mvd) associated to the largest temporal distance. The mvd associated to the smallest distance is being scaled as a function of the POC distances.

FIG. 11 illustrates an example of symmetrical MVD (SMVD). This tool encodes some motion vector information, under the constraint that the motion information of a CU is made of two symmetrical forward and backward motion vector differences, in case of bi-prediction.

The coding of CU under this constraint, called the SMVD mode, is signaled through a CU-level flag symmetrical mvd flag. This flag is coded if the SMVD mode is feasible for, i.e. if the prediction mode of the CU is bi-prediction and two reference pictures for the CU are found as follows:
The reference pictures for the current CU are searched, as the closest forward and backward reference pictures, respectively in the (L0 and L1) or (L1 and L0) reference picture lists. If not found the SMVD mode is not applicable and the symmetrical mvd flag is omitted.
If the symmetrical mvd flag is signaled and is equal to true, then:
One mvd is signaled for the L0 reference picture, and the mvd for the other reference picture list is derived as symmetrical, i.e. the opposite of the first one.
2 MV predictors indices are signaled (one per reference picture list), as in the classical AMVP mode.

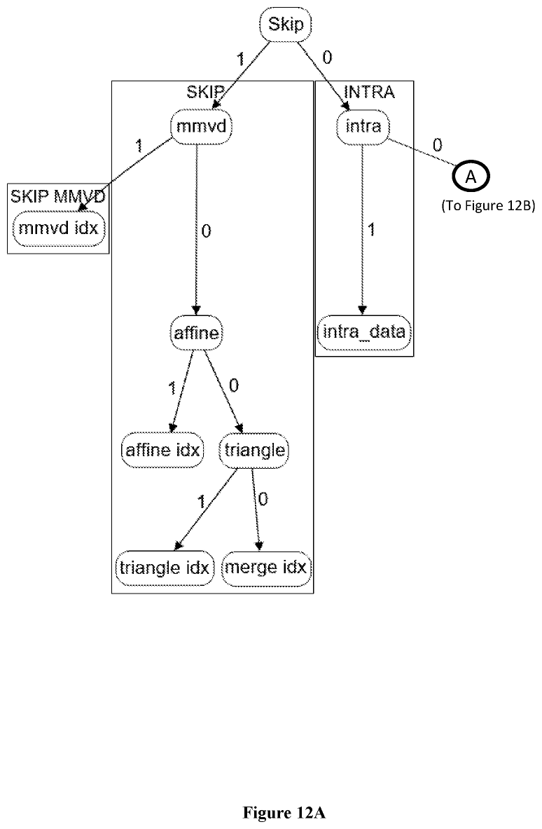

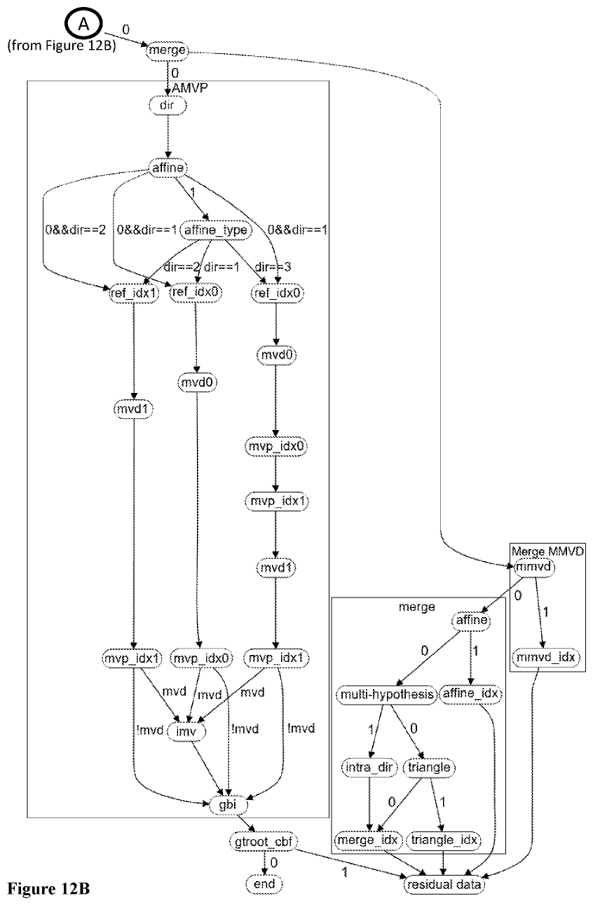

FIGS. 12A and 12B illustrate a graph representing an example syntax tree for a video codec supporting MMVD and SMVD. This example of syntax is the one proposed in VTM 3.0.

The use of tools such as MMVD or SMVD in video codecs allows to obtain good performance gains because they offer a possibility to encode the motion information at a cost between AMVP mode and MERGE mode.

In this figure, a 0 or 1 on an edge means that the path depends on the value of the flag at the source node, a string “xxx=yyy” on an edge means that the path depends on the value of a previously decoded value xxx, a string “1 && xxx==yyy” on an edge means that the path depends on the value of the flag at the source node AND the value of a previously decoded value xxx, a string “xxx?yyy” in a node means that the value yyy is read only if the flag xxx is true. The meaning of the flags skip, intra, mvd, mvp_idx, merge_idx is the same as in conventional video codecs such as HEVC for example, mvdX (mdv0 or mvd1) correspond to the mvd of the lists L0 or L1 respectively. The same principle apply to other variables (mvp, merge_idx etc.). Finally, gbi, triangle, mh (multi-hypothesis), mmvd are the modes described above. In the different syntax graphs of this document, it is assumed that when decoding the mvd in case of affine mode, several mvd can be decoded (one for each CPMV (Control Point Motion Vector)).

In order of coding cost, the motion information data signaled according to the graph illustrated in FIG. 12 are as follows:
SKIP:
   1 flag to signal skip,
   1 flag for not mmvd,
   1 to 2 flags to choose the mode
   a merge index corresponding to the mode (affine idx, merge idx etc.)
SKIP MMVD:
   1 flag to signal skip,
   1 flag for mmvd,
   a merge index for the mmvd predictor,
   a mmvd value to code the residual of motion.
MERGE:
   1 flag to signal not skip,
   1 flag to signal not intra,
   1 flag to signal merge,
   1 flag to signal not mmvd,
   1 to 3 flags to choose the mode
   a merge index corresponding to the mode (affine idx, merge idx etc.)
MERGE MMVD:
   1 flag to signal not skip,
   1 flag to signal not intra,
   1 flag to signal merge,
   1 flag to signal mmvd,
   a merge index for the mmvd predictor,
   a mmvd value to code the residual of motion.
AMVP:
   1 flag to signal not skip,
   1 flag to signal not intra,
   1 flag to signal not merge,
   1 flag for affine,
   1 or 2 motion information:
      ref idx corresponding to the index of the reference image in the reference picture buffer (RPB)
      a mvp_idx: the index of the motion vector used as a predictor to encode the current motion vector
      a mvd: motion vector difference between the motion vector to encode and the motion vector predictor
   1 flag for imv (conditionally to the presence of a mvd not null),
   a gbi index.

Using such syntax, the AMVP, MERGE, MERGE+MMVD are separated and the bi-prediction mode is exclusive for each mode, which forbids some combination of modes that would be interesting for enhancing the compression performance.

The person skilled in the art understands that the bitstream syntax and the parsing tree proposed in this document are strictly equivalent since the syntax is directly deductible from the graph and vice-versa. Moreover, some the terms used in this document can correspond to alternate terms in other video codecs but providing the same functionality or principle.

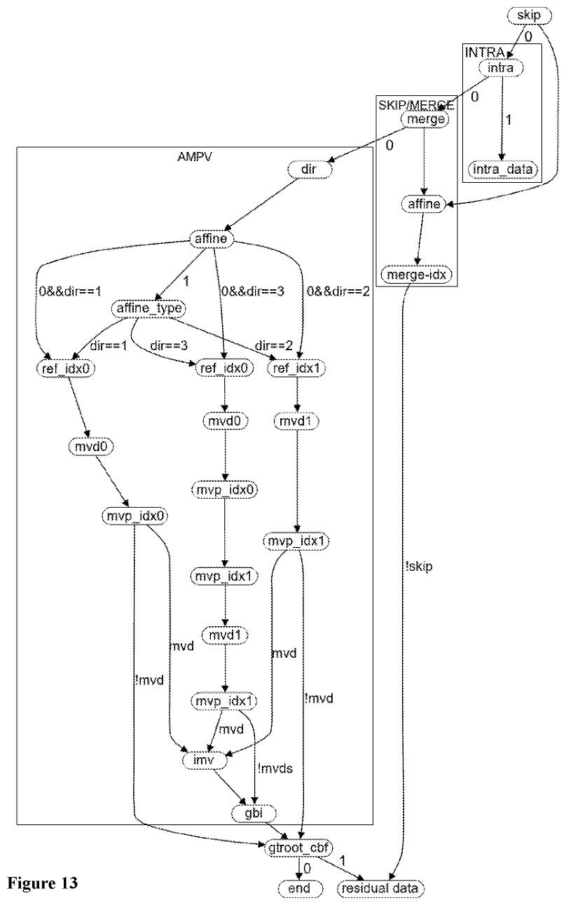

FIG. 13 illustrates a simplified version of the parsing tree of the inter mode. For the sake of simplicity and clarity, we will use this simplified version of the parsing tree of the inter mode, illustrated in FIG. 13 and corresponding to the syntax of FIG. 12 without the syntax for the triangle and multi-hypothesis modes. These modes can be added to the parsing tree at the same locations than in the full scheme of FIG. 12 and may even include more modes. For clarity reason also, the merge_idx used in regular merge or affine merge has been grouped together in the parsing tree, even if the list derivation is different. Here we assume that mmvd mode is not available. The available 4 modes are:
SKIP mode: motion information is deduced from a unique candidate identified by its index in the list of predictors
MERGE mode: motion information is deduced from a unique candidate identified by its index in the list of predictors
AMVP:
   Uni-prediction: motion information is fully described by specifying the multiple motion information parameters including direction, index of a predictor for the motion vector, a motion vector difference, etc.
   Bi-prediction: motion information is fully described for each list (L0 and L1) by specifying the multiple motion information parameters including direction, index of a predictor for the motion vector, a motion vector difference, etc.

The efficiency of the motion information coding can be measured by the number of flags/index needed to encode a mode. This is different from the actual coding cost using an entropy coding which depends on the data statistics but allows to compare easily the coding cost of different proposed syntaxes.

In the simplified conventional syntax coding of FIG. 13, the coding cost are the following:
SKIP:
   1 flag to signal skip,
   1 affine flag,
   a merge index
MERGE:
   1 flag to signal not skip,
   1 flag to signal not intra,
   1 flag to signal merge,
   1 affine flag,
   a merge index
AMVP:
   1 flag to signal not skip,
   1 flag to signal not intra,
   1 flag to signal not merge,
   1 direction (1 or 2 bits),
   1 affine flag,
      optionally 1 affine type,
   depending on the direction, 1 or 2 times the motion information:
      ref idx corresponding to the index of the reference image in the reference picture buffer (RPB)
      a mvp_idx: the index of the motion vector used as a predictor to encode the current motion vector
      a mvd: motion vector difference between the motion vector to encode and the motion vector predictor
   1 flag for imv (conditionally to the presence of a mvd not null),
   a gbi index.

Conventional codecs are comprising a step of creation of a merge list that determines a list of candidate references for the prediction.

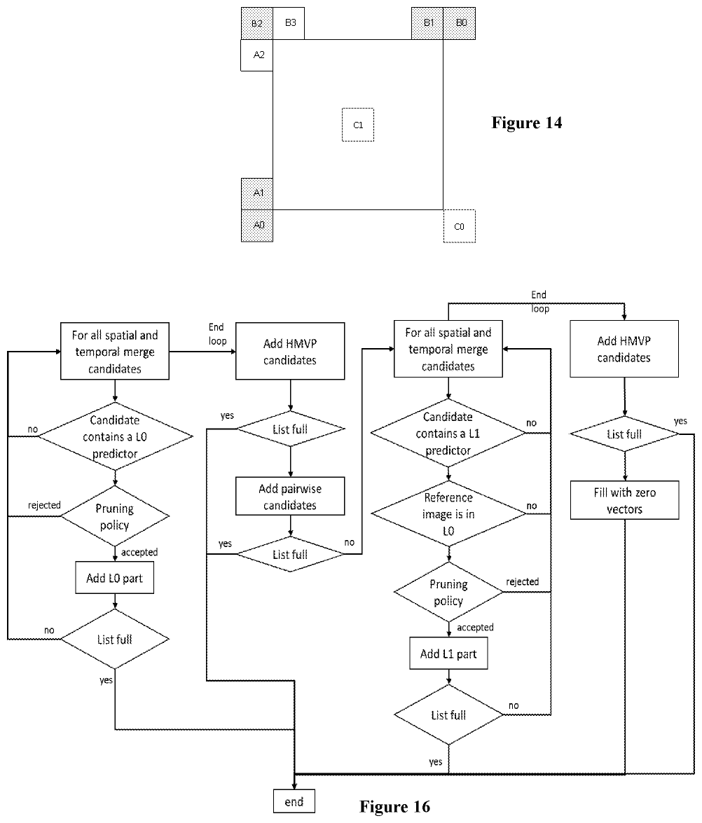

FIG. 14 illustrates the candidates used for the merge list creation in each mode of a conventional video codec such as described in VTM 3.0 for example. Depending on the motion mode, several type of candidates and list creation policy are available (note that sub-block merge list correspond to the affine flag=1 merge list). During the merge list creation, each position is examined and if the candidate exists, it is added to the list, whatever its direction (bi-prediction or uni-prediction). The details of merge candidates list in VTM 3.0 is as in the following list (spatial positions are shown in FIG. 14):
Spatial A1
Spatial B1+pruned A1
Spatial B0+pruned B1
Spatial A0+pruned A1
Spatial B2+pruned A1/B1
TMVP C0/C1 (temporal candidates)
HMVP (history based motion vector predictor) last to first+pruned all+let one space for pairwise
Pairwise of candidates (average of candidates at the specified index) {0,1}, {0,2}, {1,2}, {0,3}, {1,3}, {2,3}
Fulfill with zero

Embodiments described hereafter have been designed with the foregoing in mind. At least one embodiment relates to a new syntax for coding motion information in video coding. The motion information syntax provides better coding efficiency thanks to a finer granularity in the coding cost to encode the motion information. It provides for greater flexibility for the mode choices through an increased number of available modes related to the motion information. It also results into a unification of the syntax for clean specifications and good understandability. The motion information syntax comprises a unified syntax that comprises AMVP/MERGE and MMVD/SMVD modes for both bi-prediction or uni-prediction and introduces a new skip mode that provides a finer cost granularity. Several embodiments are described below.

An associated process is described above to encode/decode the motion information. The encoding process is implemented, for example, by the entropy coding 145, motion compensation 170 and motion estimation 175 modules of FIG. 1 The decoding process is implemented, for example, by the entropy decoding 230 and motion compensation 275 modules of FIG. 2.

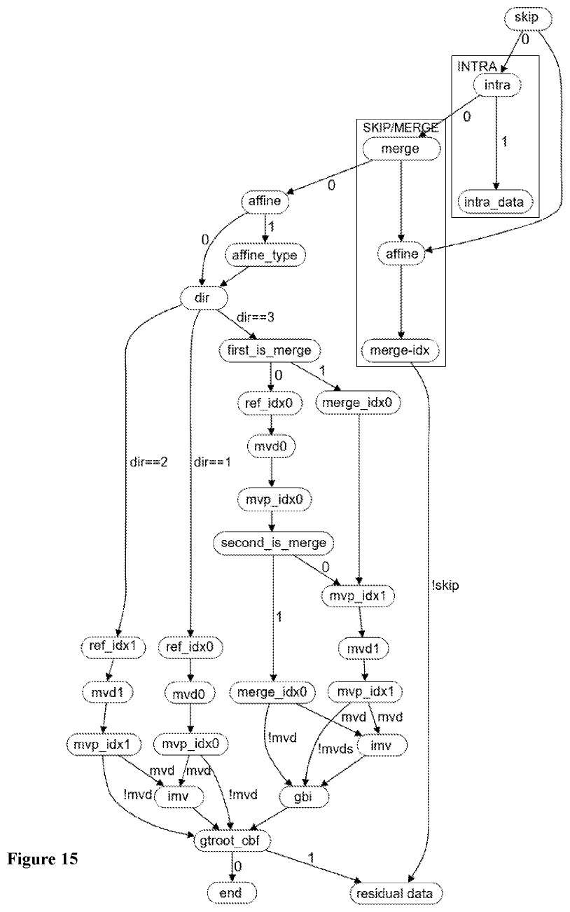

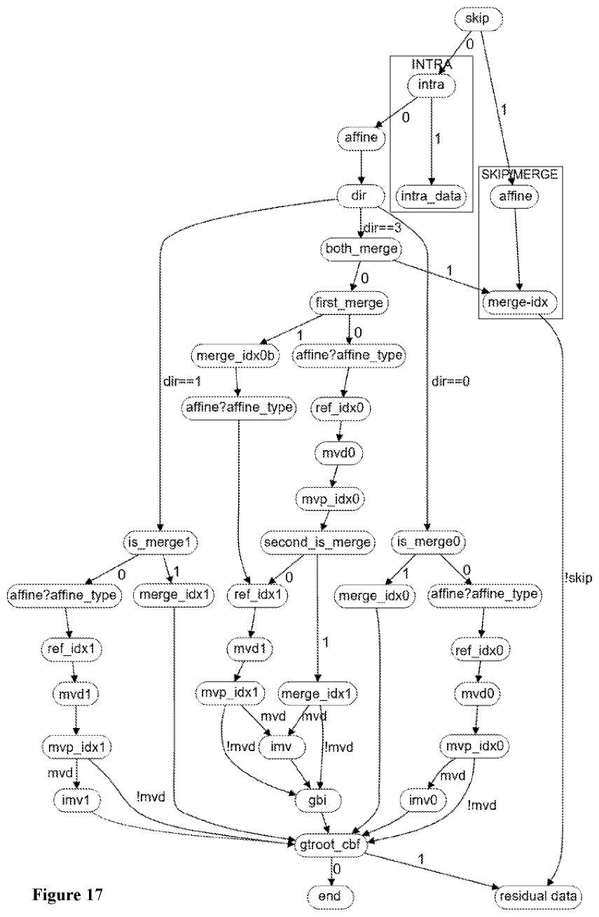

FIG. 15 illustrates a first example of motion information parsing tree according to at least an embodiment. In such embodiment, a unified syntax for AMVP and MERGE mode is proposed where only the AMVP mode is modified. The modification consists in allowing both MERGE and AMVP mode when the mode is bi-prediction (dir=3). In this case, at most one predictor (L0 or L1) can be coded in MERGE mode. In this case, the unified merge mode has 5 possibilities:
SKIP mode is unchanged
MERGE mode is unchanged
The prediction is uni-directional and the motion information is fully described, corresponding to the regular AMVP uni-prediction
The prediction is bi-directional and the motion information is fully described (first_is_merge and second_is_merge are false), corresponding to the regular AMVP bi-prediction
The prediction is bi-directional and the motion information is fully described for one prediction (first_is_merge or second_is_merge false), and the other one is deduced from the merge_idx and the candidate list. It corresponds to a new mode.

Compared to conventional coding, the coding costs are changed as followed:
SKIP: the cost is the same as before
FULL MERGE: the cost is the same as before
FULL AMVP:
   In uni-prediction: cost is the same as before
   In bi-prediction: 2 more bits are read (first_is_merge and second_is_merge)

This syntax results in the addition of a new mode that increases the number of available modes related to the motion information and thus provides greater flexibility at the cost of 2 additional bits in one of the branch for the worst case.

In order to create uni-prediction list Lx (where x is 0 or 1), the conventional list creation process described above that creates the merge list that determines a list of candidate references for the prediction is modified as follows:
First pass on the merge list:
   For each spatial and temporal candidate of the list, if the candidate contains a prediction Lx, it is added to the list,
   For each candidate of the list HMVP, if the candidate contains a prediction Lx, it is added to the list,
   The pair wise candidate are created as in the regular merge list
Second pass on the merge list:
   For each spatial and temporal candidate of the list, if the candidate contains a prediction other than Lx, with a reference image contained in the Lx list, it is added to the list,
   Optionally, For each candidate of the list HMVP, if the candidate contains a prediction other than Lx with a reference image contained in the Lx list, it is added to the list,
Fill with zero vector

In a variant embodiment for this list creation, during the second pass, if a candidate contains a prediction other than Lx but with an image of reference not contained in Lx, then the motion vector predictor is rescaled using the regular motion vector rescaling (with a rescaling to point towards the first image of reference of Lx).

For the other types of list (affine merge list, sub-block merge list etc.), the same principle applies: the candidate of the regular list are added to the uni-prediction list by taking relevant uni-directional candidates.

Note that the same pruning policy applies to the list after a candidate has been added to the list.

FIG. 16 shows an example of process for constructing a L0 uni-prediction merge list by using the merge list creation. If the merge list creation changes, the uni-prediction merge list creation is changed accordingly. In this new AMVP mode with one predictor being merged, the GBI can be treated according one of the following manners: the GBI index can always be signaled or can be inherited from the merge candidate selected in the merge part of the bi-prediction.

FIG. 17 illustrates a second example of motion information parsing tree according to at least an embodiment. In such embodiment, a unified syntax for AMVP and MERGE mode is proposed where both the MERGE mode and the AMVP mode are modified. The modification consists in unifying MERGE and AMVP modes.

In this case, the unified merge mode has 6 possibilities:
SKIP: same as before
The prediction is uni-directional and the motion information is fully described (is_merge is false), corresponding to the regular AMVP uni-prediction
The prediction is uni-directional and the motion information is predicted with a merge index and the candidate list. It corresponds to a new mode.
The prediction is bi-directional and the motion information is fully described (first_is_merge and second_is_merge are false), corresponding to the regular AMVP bi-prediction
The prediction is bi-directional and the motion information is fully described for one prediction (first_is_merge ore second_is_merge false), and the other one is deduced from the merge_idx and the candidate list. It corresponds to a new mode.
The prediction is bi-directional and the motion information is is predicted with a the merge_idx and the candidate list (corresponding to the conventional MERGE mode)

Compared to regular coding, the coding costs are changed as following:
SKIP: the cost is the same as before
FULL MERGE: Compared to regular merge, it takes one more bit (direction is bi-prediction flag).
FULL AMVP:
   In uni-prediction: one more bit is used
   In bi-prediction: 2 more bits are read (first_is_merge and second_is_merge)

This syntax illustrated in FIG. 17 results in the addition of two new modes that increase the number of available modes related to the motion information and thus provides greater flexibility at the maximal cost of two additional bits in one of the branch.

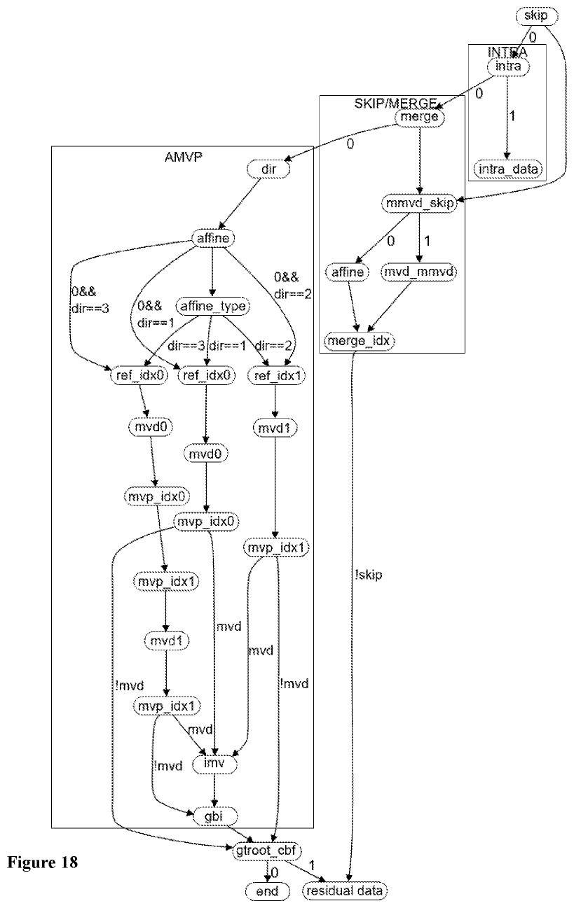

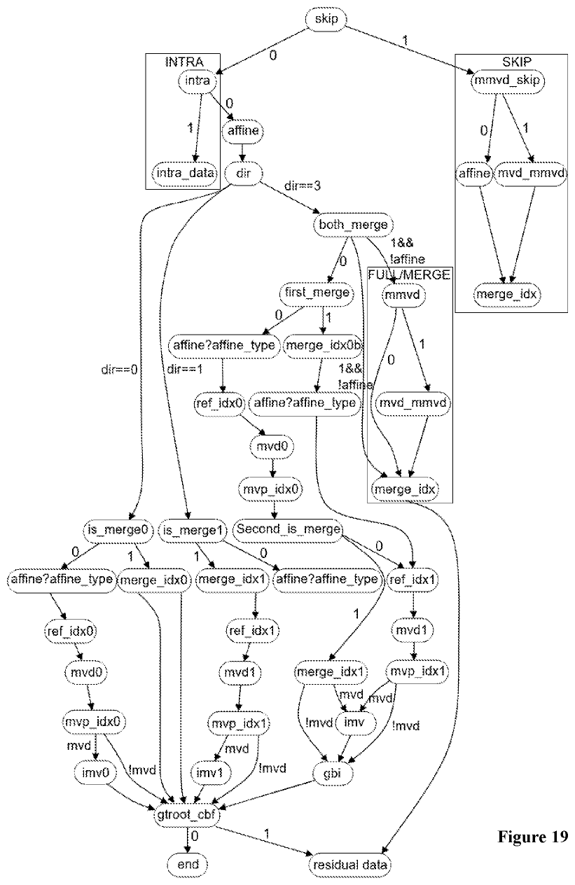

FIG. 19 illustrates a third example of motion information parsing tree according to at least an embodiment. In such embodiment, a unified syntax is proposed where MMVD mode is available. The corresponding conventional version is first introduced in order to highlight the differences. FIG. 18 illustrates a simplified view of the parsing tree of the inter mode. It corresponds to FIG. 12 but without the syntax for the triangle and multi-hypothesis modes for clarity purpose. For clarity purpose also, the mmvd_idx has been decomposed in a mvd mmvd and a merge_idx (instead of having a mmvd_idx coding both the merge index candidate (between 0 and 1) and a mvd). As before, for clarity reason, the merge_idx used in regular merge or affine merge has been grouped together in the parsing tree, even if the list derivation is different. The six available modes are:
SKIP mode: motion information is deduced from a unique candidate
SKIP MMVD: motion information is deduced from a unique candidate and a MVD is coded
MERGE mode: motion information is deduced from a unique candidate
MERGE MMVD mode: motion information is deduced from a unique candidate and a
MVD is coded
AMVP:
   Uni-prediction: motion information is fully described
   Bi-prediction: motion information is fully described for each list (L0 and L1)
      And the coding costs are:
SKIP:
   1 flag to signal skip,
   1 flag for not mmvd,
   1 affine flag,
   a merge index
SKIP MMVD:
   1 flag to signal skip,
   1 flag for mmvd
   a merge index
   a mvd
MERGE:
   1 flag to signal not skip,
   1 flag to signal not intra,
   1 flag to signal merge,
   1 flag to signal not mmvd,
   1 affine flag,
   a merge index
MERGE MMVD:
   1 flag to signal not skip,
   1 flag to signal not intra,
   1 flag to signal merge,
   1 to signal mmvd
   a merge index
   a mvd
AMVP:
   1 flag to signal not skip,
   1 flag to signal not intra,
   1 flag to signal not merge,
   1 direction (1 or 2 bits),
   1 affine flag,
      optionally one affine type,
   depending on the direction, 1 or 2 times the motion information:
      ref idx corresponding to the index of the reference image in the reference picture buffer (RPB)
      a mvp_idx: the index of the motion vector used as a predictor to encode the current motion vector
      a mvd: motion vector difference between the motion vector to encode and the motion vector predictor
   a flag for imv (conditionally to the presence of a mvd not null),
   a gbi index.

The unified syntax of the third embodiment provides 8 modes, including two new modes:
SKIP mode: motion information is deduced from a unique candidate
SKIP MMVD: motion information is deduced from a unique candidate and a MVD is coded
MERGE mode: motion information is deduced from a unique candidate
MERGE MMVD mode: motion information is deduced from a unique candidate and a MVD is coded
AMVP:
   Uni-prediction: motion information is fully described
   Bi-prediction: motion information is fully described for each list (L0 and L1)
The prediction is uni-directional and the motion information is predicted with a merge index and the candidate list. It corresponds to a new mode.
The prediction is bi-directional and the motion information is fully described for one prediction (first_is_merge ore second_is_merge false), and the other one is deduced from the merge_idx and the candidate list. It corresponds to a new mode.

With the following coding costs:
SKIP: the cost is the same as before
SKIP MMVD: the cost is the same as before
FULL MERGE: Compared to regular merge, it takes one more bit (direction is bi-prediction flag).
FULL MERGE MMVD: Compared to regular merge, it takes one more bit (direction is bi-prediction flag).
FULL AMVP:
   In uni-prediction: one more bit is used
   In bi-prediction: 2 more bits are read (first_is_merge and second_is_merge)

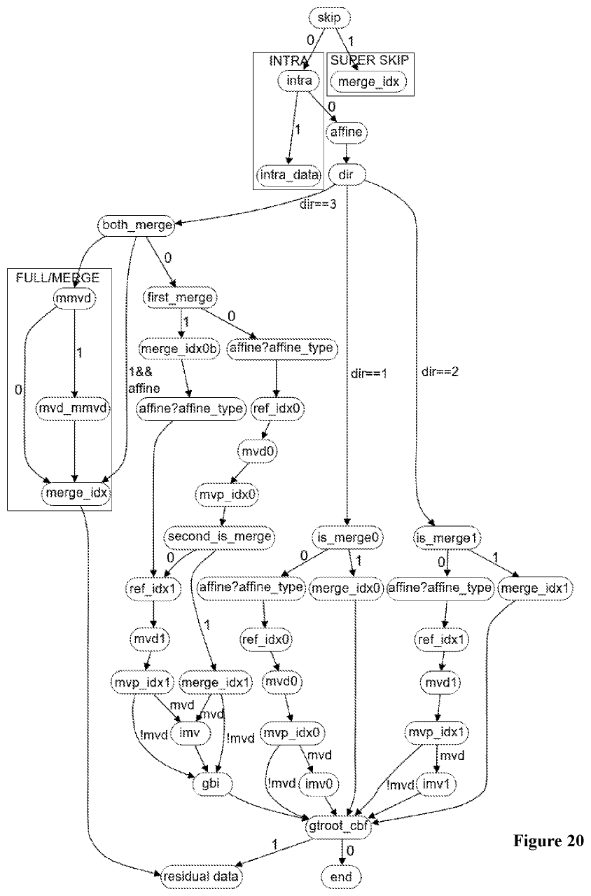

FIG. 20 illustrates a fourth example of motion information parsing tree according to at least an embodiment. In such embodiment, a unified syntax is proposed where a “super skip” replaces the conventional skip mode by removing cost from affine and mmvd modes.

In this fourth embodiment, 9 modes are available:
SKIP: motion information is deduced from a unique candidate
SKIP MMVD: motion information is deduced from a unique candidate and a MVD is coded
SUPER SKIP mode: motion information is deduced from a unique candidate. It corresponds to a new mode.
MERGE mode: motion information is deduced from a unique candidate
MERGE MMVD mode: motion information is deduced from a unique candidate and a MVD is coded
AMVP:
   Uni-prediction: motion information is fully described
   Bi-prediction: motion information is fully described for each list (L0 and L1)
HALF MERGE
   The prediction is uni-directional and the motion information is predicted with a merge index and the candidate list. It corresponds to a new mode.
   The prediction is bi-directional and the motion information is fully described for one prediction (first_is_merge ore second_is_merge false), and the other one is deduced from the merge_idx and the candidate list. It corresponds to a new mode.

With the following coding costs changes:
SUPER SKIP: (2 bits less to signal than regular skip)
1 flag to signal skip
a merge index
SKIP: 1 more bits (super_skip)
SKIP MMVD: 1 more bits (super_skip)
MERGE: Compared to regular merge, it takes 2 more bits (super_skip, direction is bi-prediction flag).
MERGE MMVD: Compared to regular merge, it takes 2 more bits (super_skip, direction is bi-prediction flag).
FULL AMVP:
   In uni-prediction: 2 more bits are used (super_skip, is_merge)
   In bi-prediction: 3 more bits are used (super_skip, first_is_merge and second_is_merge)

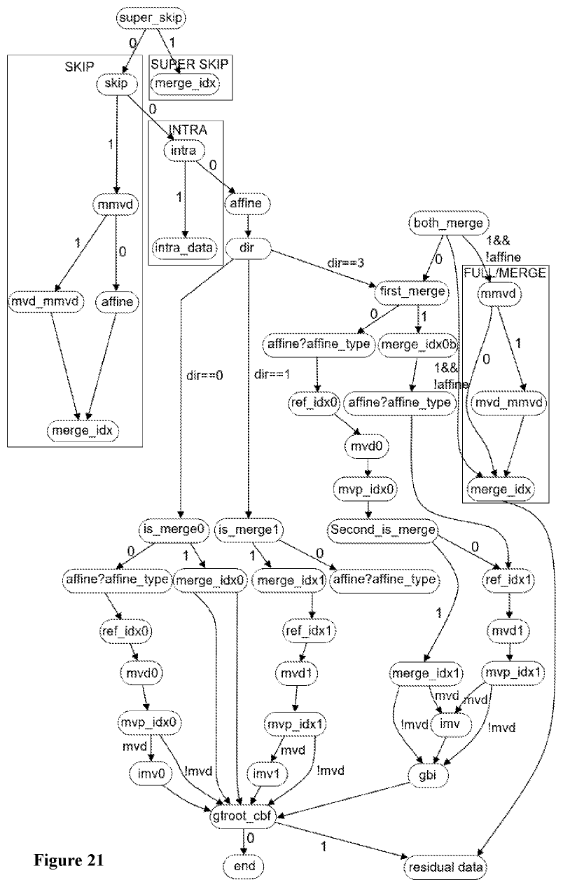

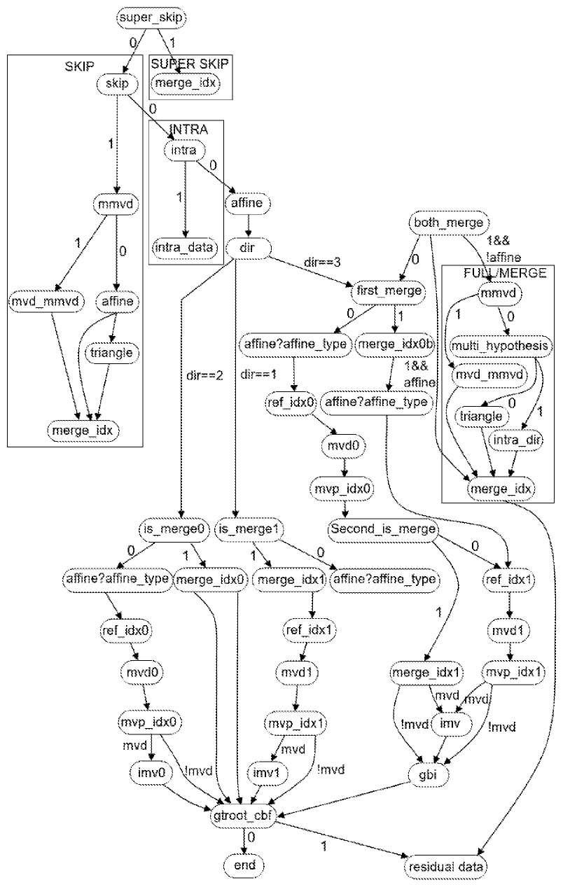

FIG. 21 illustrates a variant embodiment of the fourth example of motion information parsing tree. In such embodiment, the super skip merge list is derived as described in the fourth embodiment. As some candidates can be redundant with the normal skip mode, the normal skip mode candidates list creation is adapted as follows:
The normal merge list creation process is used, but for each candidate, it is not inserted in the list if the candidate is not of affine nature.
In a variant, the process is similar but the candidate is not inserted in the list if it was already in the super skip list.

Conversely, for the affine merge list creation in normal skip mode:
The normal affine merge list creation process is used, but without the inherited candidates at the same position as normal merge candidate.
In a variant, the process is similar but the candidate is not inserted in the list if it was already in the super skip list.

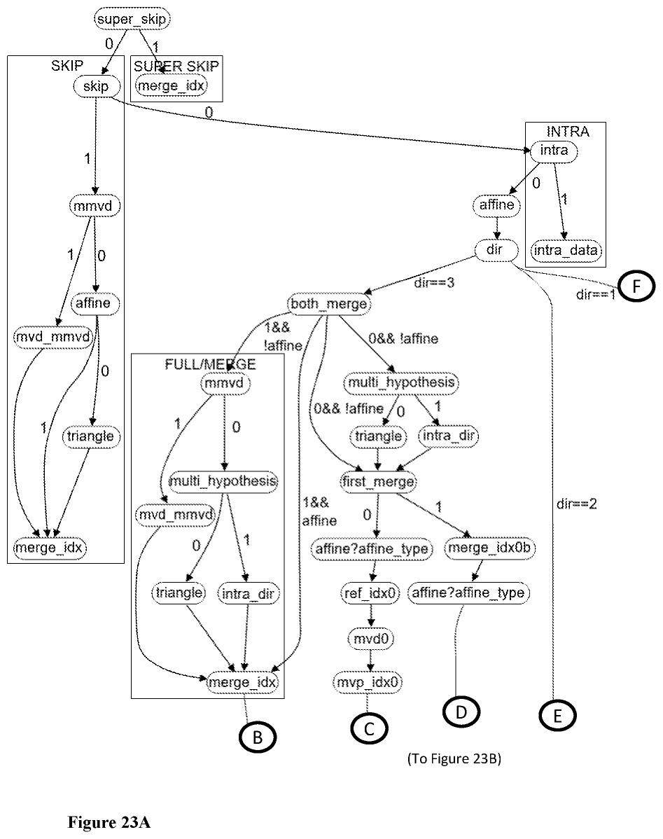

The variant embodiment described in FIG. 21 is applied to a VTM 3.0 syntax including triangle and multi-hypothesis and results in the graph illustrated in FIG. 22. Again the merge_idx of each modes (mmvd, affine, triangle, multi-hypothesis) have been merged together for clarity of the graph, even if the list creation process is different (and hence have different merge index decoding). In this variant embodiment, the triangle and multi-hypothesis mode are added in skip and regular merge only.

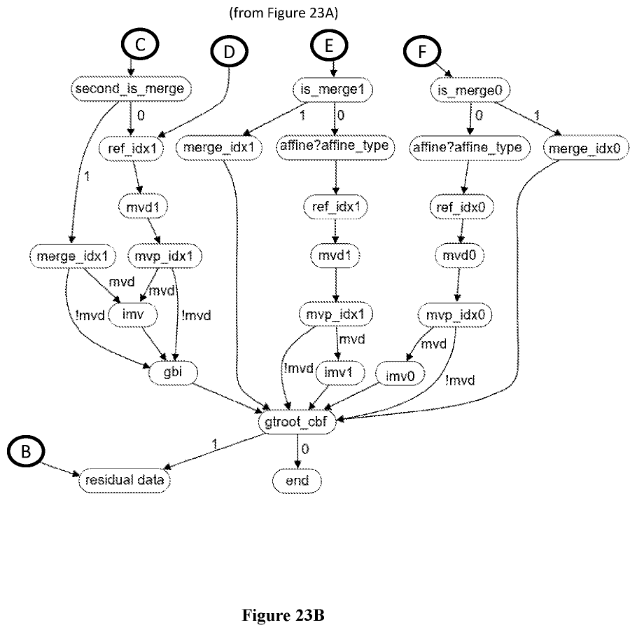

FIGS. 23A and 23B illustrate a second variant embodiment of the fourth example of motion information parsing tree. In this variant, the triangle and multi-hypothesis mode are also added in the new mode AMVP/MERGE.

In another variant not illustrated, a mode between merge and AMVP is created where the ref idx of the candidate is not transmitted in AMVP but deduced from the candidate predictor pointed by the mvp_idx.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, the embodiments presented in FIG. 1 or 2.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, the embodiments of FIG. 1 or 2.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well. The aspects described and contemplated in this application can be implemented in many different forms. FIG. 1, FIG. 2 and FIG. 3 above provide some embodiments, but other embodiments are contemplated, and the discussion of Figures does not limit the breadth of the implementations.

In the present application, the terms “reconstructed” and “decoded” may be used interchangeably, the terms “pixel” and “sample” may be used interchangeably, the terms “image,” “picture” and “frame” may be used interchangeably, the terms “index” and “idx” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined.

Various numeric values are used in the present application, for example regarding block sizes. The specific values are for example purposes and the aspects described are not limited to these specific values.

Reference to “one embodiment” or “an embodiment” or “one implementation” or “an implementation”, as well as other variations thereof, mean that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, moving the information, copying the information, calculating the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory or optical media storage). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1-17. (canceled)

18. A video decoding method comprising:
decoding a block of a video based on signaling information representative of a motion information for the block, the signaling information comprising syntax elements arranged as a syntax tree and comprising an information at the root of the syntax tree to signal that motion information is predicted from a candidate list and, directly after the information at the root of the syntax tree, an index in the candidate list of predictors;
wherein decoding includes predicting motion information from a candidate selected by an index in the candidate list of predictors comprising candidates predicted according to a plurality of modes.

19. The video decoding method of claim 18, wherein the signaling information comprises an information representative of a uni-directional prediction mode.

20. The video decoding method of claim 18, wherein the signaling information further comprises an information representative of a bi-directional prediction mode where one of the two predictors is a merge candidate and the other one is deduced from the index and the candidate list of predictors.

21. The video decoding method of claim 18, wherein the signaling information comprises an information representative of a triangle prediction mode.

22. The video decoding method of claim 18, wherein the signaling information comprises an information representative of a multi hypothesis prediction mode.

23. A video encoding method comprising:
encoding a block of a video and signaling information representative of a motion information for the block, the signaling information comprising syntax elements arranged as a syntax tree and comprising an information at the root of the syntax tree to signal that motion information is predicted from a candidate list and, directly after the information at the root of the syntax tree, an index in the candidate list of predictors;
wherein encoding includes predicting motion information from a candidate selected by an index in the candidate list of predictors comprising candidates predicted according to a plurality of modes.

24. The video encoding method of claim 23, wherein the signaling information comprises an information representative of a uni-directional prediction mode.

25. The video encoding method of claim 23, wherein the signaling information further comprises an information representative of a bi-directional prediction mode where one of the two predictors is a merge candidate and the other one is deduced from the index and the candidate list of predictors.

26. The video encoding method of claim 23, wherein the signaling information comprises an information representative of a triangle prediction mode.

27. The video encoding method of claim 23, wherein the signaling information comprises an information representative of a multi hypothesis prediction mode.

28. A video decoding apparatus comprising a decoder configured to decode a block of a video based on signaling information representative of a motion information for the block, the signaling information comprising syntax elements arranged as a syntax tree and comprising an information at the root of the syntax tree to signal that motion information is predicted from a candidate list and, directly after the information at the root of the syntax tree, an index in the candidate list of predictors; wherein decoding includes predicting motion information from a candidate selected by an index in the candidate list of predictors comprising candidates predicted according to a plurality of modes.

29. The video decoding apparatus of claim 28, wherein the signaling information comprises an information representative of a uni-directional prediction mode.

30. The video decoding apparatus of claim 28, wherein the signaling information further comprises an information representative of a bi-directional prediction mode where one of the two predictors is a merge candidate and the other one is deduced from the index and the candidate list of predictors.

31. The video decoding apparatus of claim 28, wherein the signaling information comprises an information representative of a triangle prediction mode or of a multi hypothesis prediction mode.

32. A video encoding apparatus comprising an encoder configured to encode a block of a video and signaling information representative of a motion information for the block, the signaling information comprising syntax elements arranged as a syntax tree and comprising an information at the root of the syntax tree to signal that motion information is predicted from a candidate list and, directly after the information at the root of the syntax tree, an index in the candidate list of predictors; wherein encoding includes predicting motion information from a candidate selected by an index in the candidate list of predictors comprising candidates predicted according to a plurality of modes.

33. The video encoding apparatus of claim 32, wherein the signaling information comprises an information representative of a uni-directional prediction mode.

34. The video encoding apparatus of claim 32, wherein the signaling information further comprises an information representative of a bi-directional prediction mode where one of the two predictors is a merge candidate and the other one is deduced from the index and the candidate list of predictors.

35. The video encoding apparatus of claim 32, wherein the signaling information comprises an information representative of a triangle prediction mode or of a multi hypothesis prediction mode.

36. A non-transitory computer readable medium comprising program code instructions for decoding a block of a video based on signaling information representative of a motion information for the block, the signaling information comprising syntax elements arranged as a syntax tree and comprising an information at the root of the syntax tree to signal that motion information is predicted from a candidate list and, directly after the information at the root of the syntax tree, an index in the candidate list of predictors; wherein decoding includes predicting motion information from a candidate selected by an index in the candidate list of predictors comprising candidates predicted according to a plurality of modes, when executed on a processor.

37. A non-transitory computer readable medium comprising program code instructions for encoding a block of a video and signaling information representative of a motion information for the block, the signaling information comprising syntax elements arranged as a syntax tree and comprising an information at the root of the syntax tree to signal that motion information is predicted from a candidate list and, directly after the information at the root of the syntax tree, an index in the candidate list of predictors; wherein encoding includes predicting motion information from a candidate selected by an index in the candidate list of predictors comprising candidates predicted according to a plurality of modes, when executed on a processor.
